(19) United States
(12) Patent Application Publication
(10) Pub. No.: US 2022/0325813 A1
(43) Pub. Date: Oct. 13, 2022

(54) AIR VENTILATION VALVE

(71) Applicant: PADMINI VNA MECHATRONICS LTD., Gurgaon (IN)

(72) Inventors: KABIR BHANDARI, NEW DELHI (IN); AMARDIP KUMAR, GURGAON (IN); VARUN KUMAR, Gurgaon (IN); SAHIL SINGLA, Gurgaon (IN); SHUBHAM SINGH, Gurgaon (IN)

(21) Appl. No.: 17/634,061

(22) PCT Filed: Sep. 2, 2020
(86) PCT No.: PCT/IB2020/058149

§ 371 Date: Feb. 9, 2022

(30) Foreign Application Priority Data
Aug. 10, 2019 (IN) 201911032498

(51) Int. Cl. F16K 24/04; B01D 46/12; F16K 31/06

(52) U.S. Cl. CPC F16K 24/04; B01D 46/12; F16K 31/0672; B01D 19/0063

(57) ABSTRACT

A solenoid based air ventilation valve (24) comprises of a housing (1), a solenoid coil (2), a flexible diaphragm (6), a plunger (8), a filter inlet (28) and a filter outlet assembly (100). The flexible diaphragm (6) is over molded with the plunger (8) to seal the flexible diaphragm (6) against the high pressure during closed position and has an incorporated O-ring (102) with flexible diaphragm (6) to stop the leakage from the valve (24). The filter outer assembly (100) is fixed to the inlet (25) and outlet port (26) to prevent suspended contamination particles in the valve (24). The valve (24) has a press fitted metal insert/flow controller (55) to achieve a low flow rate. Further, the air ventilation valve (24) allows a low leakage limit, low flow rate to serve high opening and working pressure to work in both over pressure and under pressure (vacuum) conditions.

### FIELD OF THE INVENTION

The present invention relates to a solenoid based air ventilation valve. More particularly, it relates to a 2/2 normally closed solenoid based air ventilation valve for providing a path to take out or fill in an amount of air to maintain the optimum air volume in the water injection system used in automobiles.

### BACKGROUND OF THE INVENTION

A solenoid based air ventilation valve (AVV) is an electromechanical device in which solenoid uses an electric current to generate the magnetic field and operate a mechanism which regulates the opening and closing of the fluid flow in a valve. In water injection system (WIS) the solenoid based air ventilation valve provides a path to take out or fill in a specific amount of air whenever required as to maintain the optimum air volume in the water injection system. The challenges faced by these valves are the low flow rate, low leakage limit, high self-opening and working pressure and the high temperature range the valve has to maintain.

In water injection system, spray of water or water with some additive is being injected into the intake manifold of the engine through a very small orifice for a short period of time whenever the temperature inside engine increases. When the water is injected, air bubbles in the pipeline of WIS decrease the effective area of the orifice and engine does not get required amount of water and water injection system does not work effectively. An air separator is generally also used to remove the air bubble from the water. In addition, there is a need of an air ventilation valve which can be mounted at the outlet of air separator to remove the accumulated air and maintain the optimum air volume in the water injection system thus preventing the pipeline from collapsing. There is a need of an automatic air ventilation valve which can work in over pressure and under pressure vacuum conditions in less response time and opens automatically whenever malfunction occurs in water injection system.

In an air ventilation valve, at high temperature trapped gas inside the chamber expands that eventually increases the pressure inside the valve which restricts the motion of the moving core and moving core may not move at nominal voltage at that particular temperature that increases Actuation voltage and response time.

FR2458730 discloses a valve provided with a ring-shaped, movable valve plate made of resilient material. The pressure prevailing in pipe line acts on one side of the valve plate, while atmospheric pressure acts on the other side of said plate, said plate other side abutting a valve seat. A ring-shaped pressure plate is arranged on the valve plate made of a ring material and around the circumference of which there is provided a guide means whose extension axially is smaller than the valve chamber in which the valve plate and pressure plate are arranged. The main drawback of this invention is that the valve functions in the occurrence of under pressure by permitting ambient air to enter said pipe line by means of said valve.

EP2652306 discloses purge air pump used according to one embodiment of the invention is integrated into the valve unit that is used for controlling air admission to the fuel vapour store. The valve unit of this kind has a valve body that interacts with a valve seat and, when it rises from the valve seat, establishes a connection between the air admission line and the environment, allowing ambient air to flow into the air admission line. Here, the closure of the valve is preferably accomplished by spring that passes the valve body against the valve seat again when a corresponding pressure balance has been achieved. The main drawback of this invention is that the required pressure difference for an adequate volume flow of the order need only be about 50 mbar, so the diameter is selected for the radial pump and control element (diaphragm) of this valve unit.

Therefore, there is a need to provide an air ventilation valve which allows a low leakage limit, low flow rate to serve high opening and working pressure and which work in both over pressure and under pressure(vacuum) conditions. Further, there is a need of an air ventilation valve that allows release of trapped gases and pressure to prevent any restriction to motion of moving core.

### OBJECT OF THE INVENTION

The main object of the present invention is to provide a solenoid based air ventilation valve used to open or shut off a pressurized media space by electrical switching to maintain an optimum air volume inside the water injection system used in automobiles.

Another object of the present invention is to provide a solenoid based air ventilation valve incorporated with filter mesh to prevent contamination inside the valve.

Yet another object of the present invention is to provide a solenoid based air ventilation valve to provide a low leakage limit and low flow rate through metal insert of small orifice.

Yet another object of the present invention is to provide a solenoid based air ventilation valve to provide a diaphragm over-molded with plunger to seal it against the high pressure fluid.

Yet another object of the present invention is to provide a solenoid based air ventilation valve comprising a breath hole that allows release of trapped gases and pressure to prevent any restriction to motion of moving core.

Still another object of the present invention is to provide a solenoid based air ventilation valve to work in over pressure and under pressure (vacuum) conditions.

### SUMMARY OF THE INVENTION

The present invention relates to a solenoid based air ventilation valve. More particularly, it relates to a 2/2 normally closed solenoid based air ventilation valve for providing a path to take out or fill in an amount of air to maintain the optimum air volume inside the water injection system used in automobiles.

In main embodiment, the present intention relates to a solenoid based air ventilation valve for maintaining an optimum air volume inside the water injection system used in automobiles. The solenoid based air ventilation valve comprises of housing with mounting flange, a solenoid coil having a fixed core and a moving core, a bracket, a flexible diaphragm over- molded with plunger. a filter assembly and a breath hole assembly. The filter assembly is fixed to the inlet and outlet port to prevent suspended contamination particles in the valve. The flexible diaphragm is over molded with plunger to seal the flexible diaphragm against the high pressure during closed position and has an incorporated 0-ring with diaphragm to stop the leakage from the valve. The valve has a press fitted metal insert of a 0.3 mm diameter called flow controller to achieve a low flow rate. Further, flexible diaphragm is designed to provide a leak proof coil housing to remain effective during the translational motion of valve. The breath hole assembly comprises of a membrane that ensures that pressure inside always remains regularized and a membrane cap that prevents direct impact from water.

### BRIEF DESCRIPTION OF THE DRAWING

FIG. 1 is an exploded view of air ventilation valve in accordance with an embodiment of the present invention.

FIGS. 2(a), 2(b), 2(c), 2(d), 2(e) and 2(f) is a perspective view of solenoid based air ventilation valve for water injection system, filter inlet, filter outlet, an assembly of filter cap and filter seat, different views of filter cap and rubber terminal seal in accordance with an embodiment of the present invention.

FIG. 3(a) and FIG. 3(b) is a sectional view of solenoid based air ventilation valve in accordance with an embodiment of the present invention.

FIG. 4(a) and FIG. 4(b) is a perspective view of spring loaded diaphragm position of solenoid based air ventilation valve and over-molded diaphragm in accordance with an embodiment of the present invention.

FIG. 5 is an assembly of flow controller in accordance with an embodiment of the present invention.

FIGS. 6(a) and FIG. 6(b) is a perspective view and sectional view of solenoid based air ventilation valve with breath hole assembly respectively in accordance with an embodiment of the present invention.

FIG. 7(a) and FIG. 7(b) is a sectional view of the breath hole assembly before and after welding respectively in accordance with the present invention.

FIG. 8 is a perspective view of the membrane cap in accordance with the present invention.

FIG. 9 is a perspective view of the housing of the air ventilation valve in accordance with the present invention.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention relates to a solenoid based air ventilation valve. More particularly, it relates to a 2/2 normally closed solenoid based air ventilation valve for providing a path to take out or fill in an amount of air to maintain the optimum air volume inside the water injection system used in automobiles.

In the main embodiment, the present invention relates to a solenoid based air ventilation valve for maintaining the optimum air volume inside the water injection system used in automobiles. The solenoid based air ventilation valve comprises of a housing with mounting flanges, a solenoid coil having a fixed core supported by a pole plate, a moving core, a bush, a bracket, a flexible diaphragm over-molded with a plunger, a filter assembly and a breath hole assembly. The filter assembly is fixed to the inlet and output port to prevent the suspended contamination when pressure is applied on the valve. The flexible diaphragm is over-molded with the plunger to seal the diaphragm against high pressure during closed position and has an incorporated O-ring with flexible diaphragm to stop the leakage from the valve. The valve has a press fitted metal insert of a 0.3 mm diameter called flow controller to achieve a low flow rate. Further, flexible diaphragm is designed to provide a leak proof coil housing to remain effective during the translational motion of valve. The breath hole assembly comprises of a membrane that ensures that pressure inside always remains regularized and a membrane cap that prevents direct impact from water. The membrane is incorporated so that pressure inside the valve always remains regularized whether it be high pressure condition or low pressure condition. The risk of under pressure is totally eliminated by this concept. The membrane is welded using preferably ultrasonically welding thus assembly on the valve becomes easy and leak proof. The membrane cap is attached over the membrane to prevent direct impact of the splash water. The membrane cap is provided a hole for release of pressure from the system and energy directors that enable a strong weld with the surface of the housing assembly. The housing has a projection that provides support to the membrane cap. For ultrasonic welding, the energy directors are required to concentrate the energy of the vibration in a smaller area so that the heat generated due to vibration melts parts and properly get a welding joint. Release of trapped and expanded gases ensures smooth movement of moving core. At high temperatures, the valve gets actuated at nominal voltage due to the breath hole assembly and the response time also decreases.

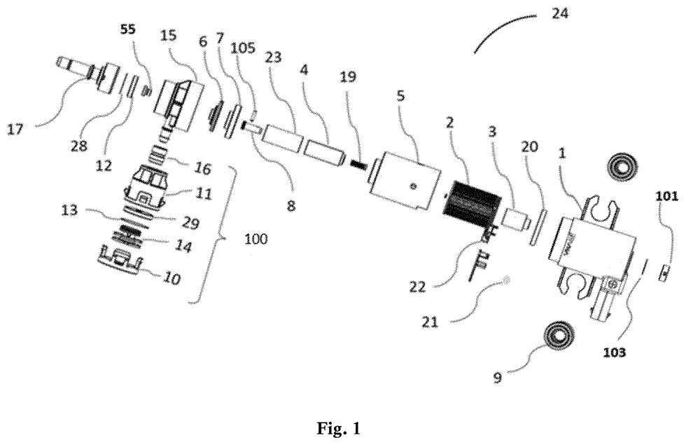

Now referring to FIG. 1, in an embodiment the present invention provides an exploded view of solenoid based air ventilation valve 24 comprising housing 1 with mounting flanges and includes a solenoid coil 2 having a fixed core 3 supported by a pole plate 20 and a moving core 4, a bush 23, a bracket 5 which is over molded with plastic to provide an insulation covering to solenoid coil 2, a flexible diaphragm 6 with a diaphragm holder 7 held with a plunger 8 with the help of a pin 105 to hold the flexible diaphragm 6 and restrict its motion. The pole plate 20 is press fitted to the fix core 3 to hold it and keep the position fixed. The pole plate 20 plays a major role in restricting the magnetic field lines path. As field line passes through bracket 5, pole plate 20, fix core 3, moving core 4 and again bracket 5 that makes a closed loop path so the constrained magnetic field line path is formed by the pole plate 20. The moving core 4 opens and closes the valve 24 when it is energized and de-energized, hence the bush 23 is used for constrained motion of moving core. The bush 23 guides the movement of moving core 4. The flexible diaphragm 6 separates the solenoid part of valve from the venting part of valve. The sealing force is achieved through a spring 19 placed at the bottom of the moving core 4 of solenoid coil 2. The housing 1 has a set of damping elements (shock mount and torque limiter) 9 and attached to the housing 1. Filter outlet assembly 100 is attached to the nozzle (atmosphere) 15. The filter outlet assembly 100 comprises of a filter cover 10 to cover the filter body 11. The filter body 11 further holds a filter seat 29, a filter outlet 13 and a filter cap 14 which prevents the suspended contamination particles in the air ventilation valve 24. Filter cap 14 also prevents the filter outlet 13 from leaving its position as it presses the filter outlet 13 on the filter seat 29. Filter body 11 is connected to nozzle (atmosphere) 15 through a filter bush 16. An inlet nozzle 17 is connected to nozzle (atmosphere) 15 through a filter holder 12, a flow controller 55 of a small orifice of 0.3 mm diameter to achieve a low flow rate. The flow controller 55 is press fitted inside the nozzle (atmosphere) 15 during the assembly process. At least two terminals 22 are provided to connect electrical connector through which electrical input is provided to coil 2. The terminals 22 connect external power source to provide power input to the coil 2. A diode 21 is provided to control the back EMF (Electro Motive Force) that is generated during de-energization of the valve 24. As the valve gets energized from any power source, the current goes into coil and if it is de-energized, the current changes its direction (at this point a back EMF is generated) and gets back into the power source and it causes harm to the power source. Diode 21 prevents such harm to the power source as it restricts the back EMF.

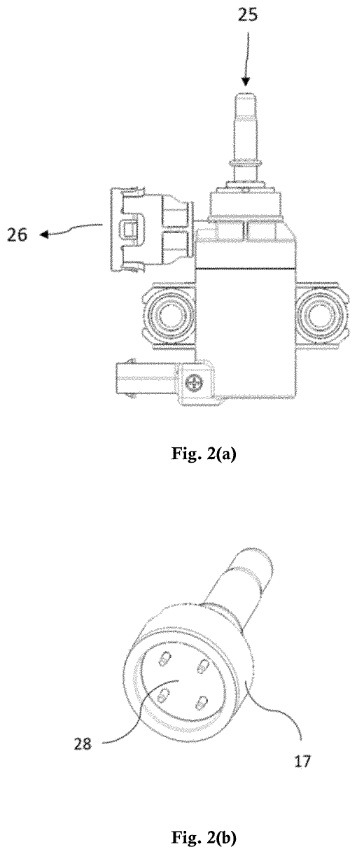

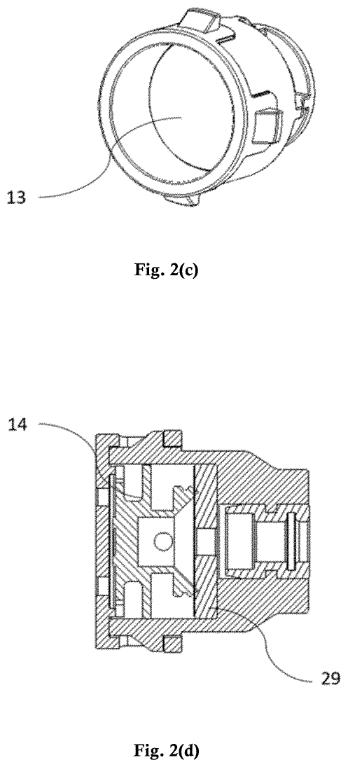

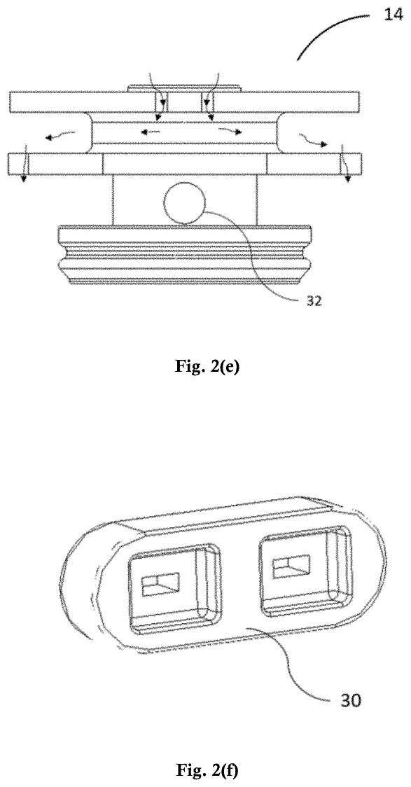

Now referring to FIGS. 2(a), 2(b), 2(c), 2(d), 2(e) and 2(f) in an embodiment of the present invention provides perspective view of solenoid based air ventilation valve which has an integrated filter at inlet 25 and outlet port 26. Two mesh filters namely filter inlet 28 and filter outlet 13 has been incorporated in solenoid based air ventilation valve 24. Filter inlet 28 is placed inside the nozzle inlet 17 and prevents any contamination beyond the mesh size of the filter to enter the valve when pressure is applied on the nozzle inlet 17. Four projections are provided inside the nozzle inlet 17 and four through holes on the surface of the filter Inlet 28 and filter holder 12. After assembly of filter Inlet and filter holder the projections of nozzle inlet are hot sealed to provide static stability to the filter inlet 28. Filter outlet 13 is placed between filter cap 14 and filter seat 29. Filter seat 29 makes a compressive static butting surface for the filter so that its position does not get changed during operation. In addition to the filter outlet 13, filter cap 14 also helps in removing suspended contamination particles. Filter cap 14 comprises of a maze like structure which circulates the air around the periphery of the filter cap 14 resulting in removal of larger particles. The orifice 32 present at the bottom of the filter cap 14 helps in passing the fluid through the valve. Filter cap 14 also prevents the filter outlet from leaving its position as it presses filter outlet 13 on the filter seat 29. Solenoid coil 2 is energized whenever ventilation is required and it releases the pressure within controlled flow which is maintained with the orifice 34 of metal insert/flow controller 55. The rubber terminal seal 30 is provided on the terminals of housing 1 to prevent the leakage from the valve.

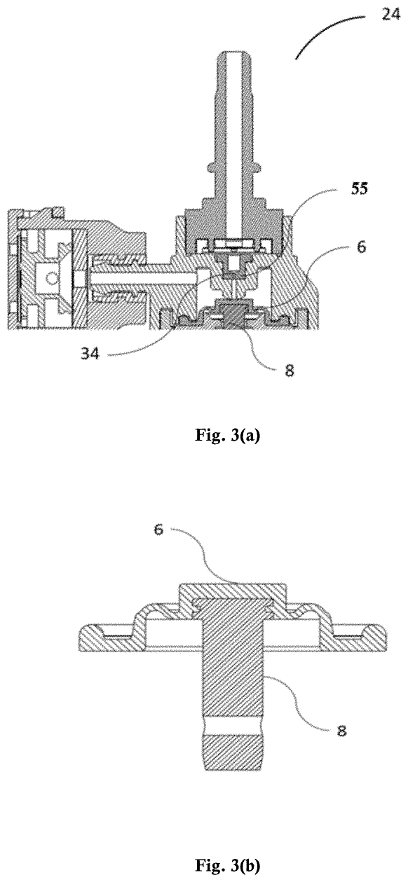

Now referring to FIG. 3(a) and FIG. 3(b), in an embodiment of the present invention provides a sectional view of air ventilation valve 24. The air ventilation valve 24 is 2/2 normally closed solenoid valve incorporated with the filter mesh at inlet and outlet port. A metal insert 55 with an orifice 34 of preferably 0.3 mm diameter called as flow controller has been adopted to meet the flow requirement. The diaphragm 6 has been over molded with a plunger 8 so that if there is any vacuum in the system, it does not stuck with the seal during actuated condition & holds the diaphragm 6 in ideal under energized condition. Further, diaphragm 6 is designed to provide leak proof coil housing and it is flexible so it remains effective during the translational motion of solenoid.

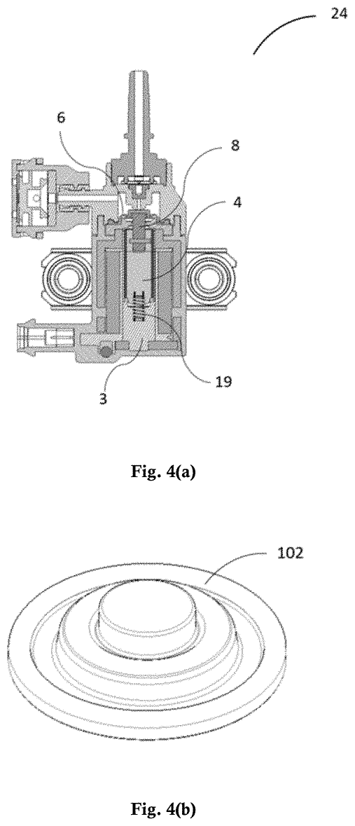

Now referring to FIG. 4(a) and FIG. 4(b), in an embodiment of the present invention provides a perspective view of spring loaded diaphragm position of air ventilation valve 24. The diaphragm's sealing force comes from the spring 19 placed at the bottom of the moving core 4 of solenoid coil 2. The edge of the diaphragm 6 gets pressed inside the groove in the nozzle (atmosphere) 15 thereby making a seal for operating fluid. The process works as: in idle condition, the spring 19 keeps the diaphragm 6 into sealed condition so any fluid pressure is compensated through spring load 19. In actuated condition, when the solenoid coil 2 is energized, the moving core 4 along with the plunger 8 and diaphragm 6 gets pulled down towards the fixed core 3 thus connecting the inlet port 25 to outlet port 26. The diaphragm 6 is over-molded with the plunger 8 to seal against the high pressure fluid. It also comprises of an O-ring 102 to stop the leakage from the valve.

The air ventilation valve 24 has a high burst pressure. To prevent the joints of valve from snapping at a burst pressure of 40 bar and to make it leak-proof, laser (light amplification by stimulated emission of radiation) welding operation is carried out at junction. The welding is carried out at the assembly point of nozzle inlet 17 and nozzle (atmosphere) 15 and housing sub assembly 1.

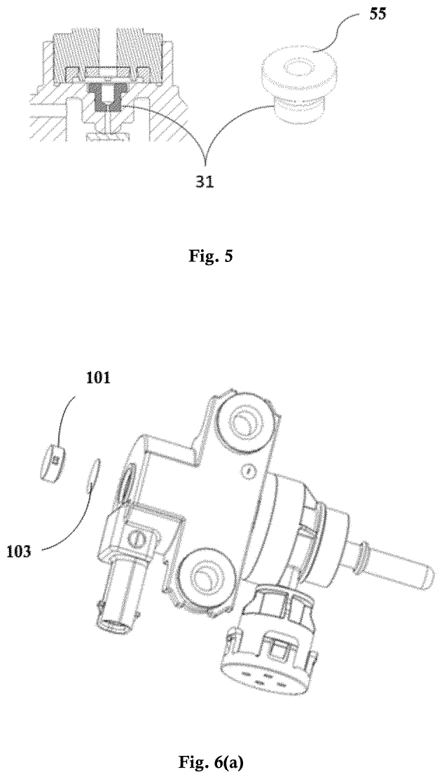

Now referring to FIG. 5, the present invention provides an assembly of flow controller 55 in the nozzle atmosphere. The nozzle atmosphere has a cavity in which the flow controller is assembled through the interference fit. Flow controller has a small projection 31 on its outer diameter to avoid the possibility of any leak through the joint.

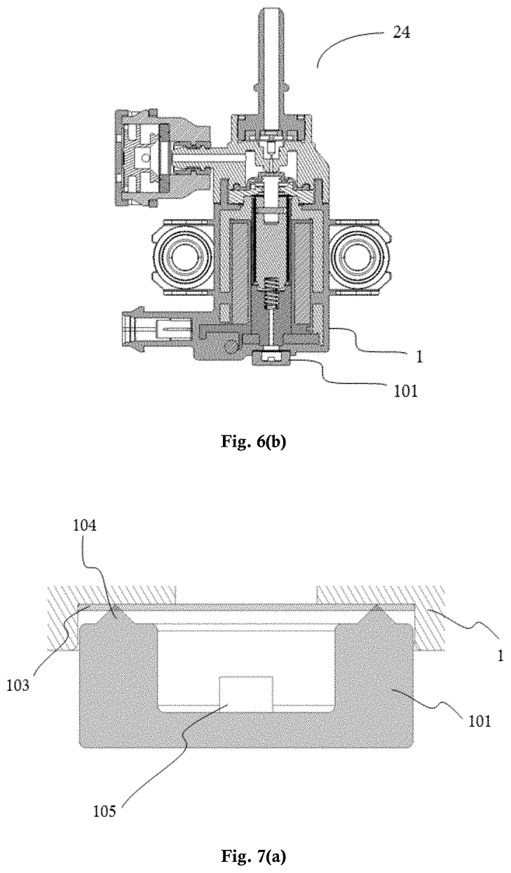

Now referring to FIG. 6(a) and FIG. 6(b), the present invention provides a perspective and sectional view of the solenoid based air ventilation valve 24 for a breath hole. The breath hole assembly is attached to the bottom of the housing and has two parts i.e. a membrane 103 and a membrane cap 101. The membrane 103 is to be incorporated with the valve so that the pressure inside that valve always remains regularized in all condition. All condition includes a high pressure condition or a low pressure condition. The membrane 103 is ultrasonically weld able to the valve. The membrane cap 101 is located on top of the membrane 103 to prevent the direct impact of splash water. The membrane cap 101 is also ultrasonically weld able. The membrane cap 101 is provided with an energy director to weld it on the surface of housing 1. The projection on the housing 1 is provided for supporting the membrane cap 101.

As at higher temperature, trapped gas inside the chamber expanded that will increase the pressure inside the valve which restrict the motion of moving core and moving core may not move at nominal voltage at that particular temperature that increases Actuation voltage and response time. So to avoid such problems a breath hole assembly is added into the chamber to release expanded gas and also to release the pressure.

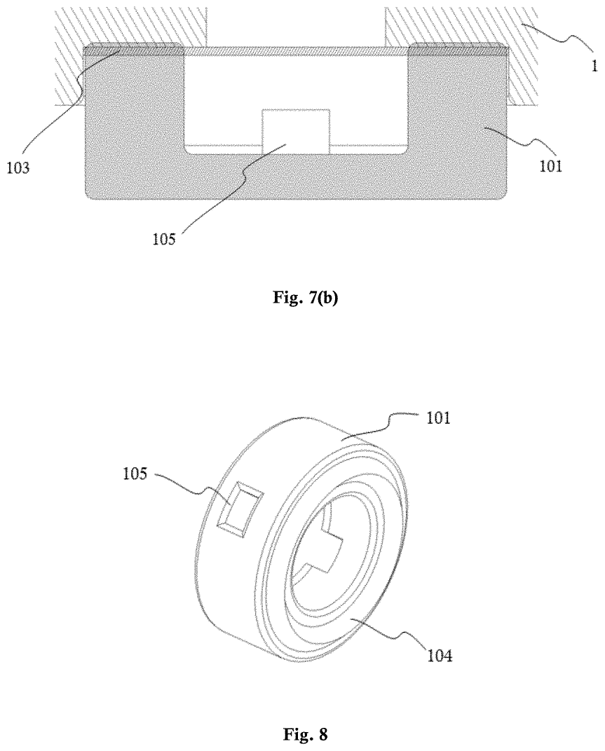

Referring to FIG. 7(a) and FIG. 7(b), a sectional view of the breath hole assembly before and after welding is shown respectively in accordance with the present invention. The membrane cap 101 has energy directors 104 to weld it to the surface of the housing 1 as shown in FIG. 7(a). The energy directors 104 during ultrasonic welding experience vibration that melts them to create a strong and proper joint as shown in FIG. 7(b).

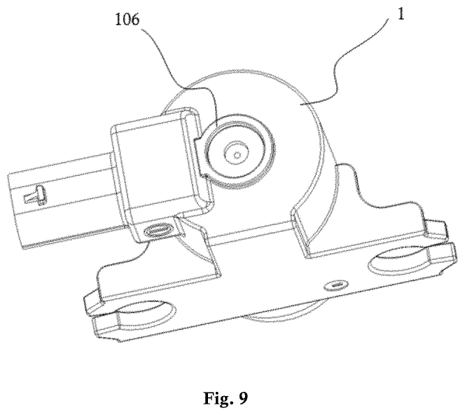

Referring to FIG. 8, a perspective view of the membrane cap is shown in accordance with the present invention. The membrane cap 101 also has a hole 105 for release of pressure from the valve.

Referring to FIG. 9, a perspective view of the housing of the air ventilation valve is shown in accordance with the present invention. The housing 1 has a projection 106 to provide support to the membrane cap.

Therefore the solenoid based air ventilation valve in the present invention has a leakage proof housing with an integrated filter assembly to prevent any contamination to enter the valve. The valve has a low leakage, small packaging area and high burst pressure. All the materials used are laser weld able to sustain high pressure.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A solenoid based air ventilation valve (24) comprising:
a housing (1);
a solenoid coil (2) comprising a fixed core (3) and a moving core (4);
a bracket (5) to provide an insulation covering to the solenoid coil (2);
at least one spring (19) placed at the bottom of the moving core (4);
a flexible diaphragm (6) with a diaphragm holder (7);
a nozzle (15) with a nozzle inlet (17);
a filter holder (12);
a flow controller (55);
a filter inlet (28) assembled inside the nozzle inlet (17);
a breath hole assembly; and
a filter outlet assembly (100) attached to the nozzle (15);
wherein,
the flexible diaphragm (6) is over-molded with a plunger (8) to seal the flexible diaphragm (6) against high pressure during closed position and has an incorporated O-ring (102) with diaphragm (6) to stop the leakage from the valve;
the filter outlet assembly (100) comprises a filter body (11) is connected to the nozzle (15) through a filter bush (16), the filter body (11) comprises a filter seat (29), a filter outlet (13) and a filter cap (14), wherein the filter body (11) prevent the suspended contamination particles in the air ventilation valve (24); and a filter cover (10) to cover the filter body (11);
the filter inlet (28) and filter outlet (13) are mesh filters and filter inlet (28) prevents any contamination beyond mesh size to enter the valve (24);
the breath hole assembly comprises a membrane cap (101) with a hole (105) to release trapped gases and a membrane (103) welded at the bottom of the housing (1); and
the membrane (103) keeps the pressure inside that valve (24) always remain regularized in all pressure conditions.

2. The solenoid based air ventilation valve (24) as claimed in claim 1, wherein the filter cap (14) prevents the filter outlet (13) from leaving its position as it presses the filter outlet (13) on the filter seat (29).

3. The solenoid based air ventilation valve (24) as claimed in claim 1, wherein at least four projections are provided inside the nozzle inlet (17) and four through holes on the surface of the filter inlet (28) and filter holder (12).

4. The solenoid based air ventilation valve (24) as claimed in claim 1, wherein the filter cap (14) comprises a maze like structure to circulate the air around the periphery of the filter cap (14) resulting in removal of larger particles.

5. The solenoid based air ventilation valve (24) as claimed in claim 1, wherein a metal insert (55) with an orifice (34) having a diameter of 0.3 to 0.33 mm adopted to meet the flow requirement.

6. The solenoid based air ventilation valve (24) as claimed in claim 1, wherein the diaphragm (6) is flexible to remains effective during the translational motion of the solenoid coil (2) and provide leak proof housing (1).

7. The solenoid based air ventilation valve (24) as claimed in claim 1, wherein at idle condition, the spring (19) keeps the diaphragm (6) into sealed condition so any fluid pressure is compensated through spring load.

8. The solenoid based air ventilation valve (24) as claimed in claim 1, wherein at actuated condition, the solenoid coil (2) is energized for activating the moving core (4) to move along with the plunger (8) and for pulling down the diaphragm (6) towards the fixed core (3) thereby connecting the inlet port (25) to outlet port (26).

9. The solenoid based air ventilation valve (24) as claimed in claim 1, wherein the flow controller (18) has a small projection (31) on its outer diameter to avoid the possibility of any leak through the joint.

10. The solenoid based air ventilation valve (24) as claimed in claim 1, wherein a rubber terminal seal (30) is provided on the terminals of housing (1) to prevent the leakage from the valve.

11. The solenoid based air ventilation valve (24) as claimed in claim 1, wherein the membrane cap (101) and membrane (103) are welded to the housing through energy directors (104) that melt during welding.

12. The solenoid based air ventilation valve (24) as claimed in claim 1, wherein the membrane cap (101) and membrane (103) are welded preferably though ultrasonic welding.
